(19) United States
(12) Patent Application Publication
(10) Pub. No.: US 2022/0261786 A1
(43) Pub. Date: Aug. 18, 2022

(54) SYSTEM AND METHOD FOR NFC TRANSACTIONS ON USER MOBILE DEVICES

(71) Applicant: SYNERGISTIC FINANCIAL NETWORKS PRIVATE LIMITED INDIA, Mumbai (IN)

(72) Inventors: Alok ARORA, Andheri East Mumbai (IN); Bhushan THAKER, Mumbai (IN); Sameer CHUGH, Mumbai (IN)

(21) Appl. No.: 17/340,362

(22) Filed: Jun. 7, 2021

(30) Foreign Application Priority Data
Feb. 18, 2021 (IN) 202121006745

(51) Int. Cl. G06Q 20/32; G06Q 20/34; G06Q 20/40; G06Q 20/20

(52) U.S. Cl. CPC G06Q 20/3278; G06Q 20/356; G06Q 20/3223; G06Q 2220/00; G06Q 20/3255; G06Q 20/4018; G06Q 20/20; G06Q 20/352

(57) ABSTRACT

A system for facilitating a Near-Field Communication (NFC) transaction comprising a user's NFC-enabled electronic device, a user's NFC-enabled card, and a transaction server is disclosed. The user's NFC-enabled electronic device includes a background NFC service (BNS) and applications. The applications may be configured to provide an NFC transaction request including recipient information to the BNS via service calls. The BNS may be configured to provide the recipient information and card details associated with the user's NFC-enabled card to the transaction server. Further, the transaction server may be configured to provide the recipient information and the card details to a transaction processor, an acquirer bank, or an issuer bank. A method, an NFC-enabled electronic device, and a transaction server for facilitating the NFC transaction is also disclosed.

### FIELD OF INVENTION

The present disclosure relates in general to digital transactions and transaction validation methods. More particularly, the present disclosure relates to a system and method for facilitating a Near Field Communication (NFC) transaction on user mobile devices.

### BACKGROUND OF THE INVENTION

Card based transactions may broadly be categorized as one of either card-present transactions, where the card physically interacts with or is in close proximity to a point-of-sale (POS) system, or card-not-present transactions, where the card is remotely used for concluding a transaction, for example, on a website or using a mobile application. For card-not-present transactions, customers are required to either manually provide sensitive card details such as card number, name on card, card expiration date, and card verification value (CVV) on the merchant transaction system or some of such sensitive card details may be pre-stored with the merchant or an associated transaction system used by the merchant. Many countries also require additional authentication such as one-time passwords (OTP) for card-not-present transactions which the customer then provides to the merchant transaction system. Storage of information indicative of sensitive card details on merchant transaction systems are susceptible to data breaches. Further, success rates for card-not-present transactions are typically lower compared to card-present transactions.

For card-present transactions, customers typically hand over their cards to the merchant for insertion or swiping on a merchant POS system. While contactless merchant POS systems are available with a few merchants, such systems also occasionally require the card to physically contact or be in close proximity to the merchant POS system or the merchant.

There is a need for customers to eliminate any possible contact between their cards and the merchant POS system. There is also a need for customers to eliminate the need to store sensitive the information indicative of card details on the merchant transaction systems. In addition, there is need to achieve higher success rates of card based transactions and provide convenience in making the card based transactions.

### SUMMARY OF THE INVENTION

In an aspect of the present disclosure an NFC-enabled electronic device is disclosed. The NFC-enabled electronic device comprises an NFC transceiver configured to facilitate an NFC-enabled interaction between the NFC-enabled electronic device and an NFC-enabled card. The NFC-enabled electronic device also comprises a storage unit comprising a background NFC service (BNS) provided at a platform-level and applications. Further, the NFC-enabled electronic device comprises a processor configured to execute computer instructions in order perform one or more functions. The functions comprise facilitating inter-communication between the applications and the BNS via service calls. The applications may be configured to provide an NFC transaction request to the BNS via the service calls. The BNS may be configured to retrieve recipient information from the NFC transaction request and provide the recipient information from the NFC-enabled electronic device to a transaction server. The BNS may also be configured to retrieve information indicative of card details associated with an NFC-enabled card. Further, the BNS may be configured to provide the card details from the NFC-enabled electronic device to the transaction server. In addition, the BNS may be configured to receive and display a transaction status notification from the transaction server, a transaction processor, an acquirer bank, or an issuer bank. The transaction status notification may indicate a success or a failure of the NFC transaction.

In another aspect of the present disclosure a transaction server to monitor and attest an NFC transaction is disclosed. The transaction server comprises a processor configured to execute one or more predefined computer instructions in order perform one or more functions. The functions comprise receiving recipient information from applications running on an NFC-enabled electronic device of a user via a background NFC service (BNS) provided in the user's NFC-enabled electronic device and a network. The functions also include validating the recipient information. Further, the functions also include assigning a proxy terminal identification (PTID) to the user's NFC-enabled electronic device. Further, the functions include receiving card details and a security cryptogram from an NFC-enabled card of the user via the BNS and the network. The BNS may be configured to retrieve the card details and the security cryptogram from the user's NFC-enabled card in order to initiate the NFC transaction. Furthermore, the functions include providing the recipient information retrieved from each application of the applications, the PTID, the card details, and the security cryptogram to a transaction processor, an acquirer bank, or an issuer bank via the network.

In yet an aspect of the present disclosure, a system comprising a Near-Field Communication (NFC)-enabled electronic device of a user is disclosed. The NFC-enabled electronic device comprises a background NFC service (BNS) that is configured to run on the NFC-enabled electronic device at a platform-level in order to facilitate an NFC transaction. The NFC-enabled electronic device also comprises applications configured to provide an NFC transaction request to the BNS via service calls. The BNS may be configured to retrieve a recipient information from the NFC transaction request. The system also comprises an NFC-enabled card of the user. The BNS may be configured to retrieve one or more card details associated with the NFC-enabled card. Further, the system also comprises a transaction server in communication with the NFC-enabled electronic device via a network. The BNS may be configured to provide the recipient information and the card details from the NFC-enabled electronic device to the transaction server. The transaction server may be configured to provide the recipient information and the card details received to a transaction processor, an acquirer bank, or an issuer bank.

In yet another aspect of the present disclosure, a method for facilitating a Near-Field Communication (NFC) transaction by a transaction server is disclosed. The method includes a step of receiving recipient information from applications running on an NFC-enabled electronic device of a user via a background NFC service (BNS) provided in the user's NFC-enabled electronic device and a network. The method also includes a step of assigning a proxy terminal identification (PTID) to the user's NFC-enabled electronic device. Further, the method includes a step of receiving card details and a security cryptogram associated with an NFC-enabled card of the user via the BNS and the network. The BNS is configured to retrieve the card details and the security cryptogram from the user's NFC-enabled card in order to initiate the NFC transaction. Furthermore, the method also includes a step of providing the recipient information retrieved from each application of the one or more applications, the PTID, the card details, and the security cryptogram to a transaction processor, an acquirer bank, or an issuer bank via the network.

### BRIEF DESCRIPTION OF DRAWINGS

FIG. 1 is a schematic block diagram of an environment including a mobile device and a personal computer of a user, a third electronic device of a beneficiary, and a fourth NFC-enabled electronic device of an assignee in accordance with which various embodiments of the present disclosure may be implemented;

FIG. 2 is is a schematic block diagram of the user mobile device of FIG. 1, in accordance with the embodiment of the present disclosure;

FIG. 3 is a schematic block diagram of one or more modules in an application and the background NFC Payment Service (BNS) in the user mobile device of FIG. 1, in accordance with the embodiment of the present disclosure;

FIG. 4 is an exemplary flow diagram of a method for managing an NFC transaction request raised by an application in the user mobile device of FIG. 1 using a background NFC Payment Service (BNS), in accordance with one embodiment of the present disclosure;

FIG. 5 is an exemplary flow diagram of a method for managing an NFC transaction request initiated by a user using the personal computer of FIG. 1, in accordance with another embodiment of the present disclosure;

FIG. 6 is an exemplary flow diagram of a method for managing an NFC transaction request sent by the beneficiary's third electronic device of FIG. 1 to the user mobile device of FIG. 1, in accordance with yet another embodiment of the present disclosure;

FIG. 7 is an exemplary flow diagram of a method for managing an NFC transaction request sent by a user using the user mobile device of FIG. 1 to the assignee's fourth NFC-enabled electronic device of FIG. 1, in accordance with yet another embodiment of the present disclosure; and

FIG. 8 is an exemplary flow diagram of a method for managing an NFC transaction request sent by a user using the personal computer of FIG. 1 to the assignee's fourth NFC-enabled electronic device of FIG. 1, in accordance with yet another embodiment of the present disclosure.

### DETAILED DESCRIPTION

Reference will now be made in detail to embodiments of the disclosure, examples of which are illustrated in the accompanying drawings. Wherever possible, the same reference numbers will be used throughout the drawings to refer to the same or like parts.

As mentioned above, conventional payment systems, such as card transactions require the card to physically interact with or be in close proximity of POS systems. However, it may be advantageous to avoid physical interaction of the same card in instances when a customer and/or merchant may be ill. As such, online transactions have been adopted by some merchants as an alternative to physical transaction. Therefore, it may be beneficial to eliminate or otherwise minimize the interaction between a customer card and a merchant POS system. Additionally, by eliminating the interaction between a customer card and a merchant POS system, this also eliminates the need for sensitive card details to be transmitted to and/or stored on merchant transaction systems that may include, but not limited to, merchant internal systems, for example, merchant applications and/or databases, or partners of merchants, such as gateways, processors, and financial networks. Thus, sensitive payment information and/or private customer information may be protected from, for example, capture or unauthorized access.

Currently, various conventional methods may utilize user electronic devices to partially facilitate payment transactions via digital tokens, manual entry, or other such methods of transmitting card data. However, such conventional methods provide card details to a merchant where the merchant is responsible for facilitating the payment transaction. As such, sensitive card details may still be transmitted to and/or stored on merchant transaction systems. As such, some amount of interaction with a merchant is still required, which again exposes information (e.g., sensitive payment information and/or private customer information) to, for example, capture or unauthorized access.

As such, it may be beneficial for a system and method to facilitate NFC transactions on or from user electronic devices. Such NFC transactions may operate using either card-present or card-not-present transactions. Further, such NFC transactions may allow the provision of recipient details and card details obtained from one or more user electronic devices to a transaction server, acquirer, transaction processor, and/or issuer to complete the transaction. As such, the payment transaction may be completed without interaction with a merchant POS system, which avoids transmitting information to and storing sensitive card details on the merchant transaction server.

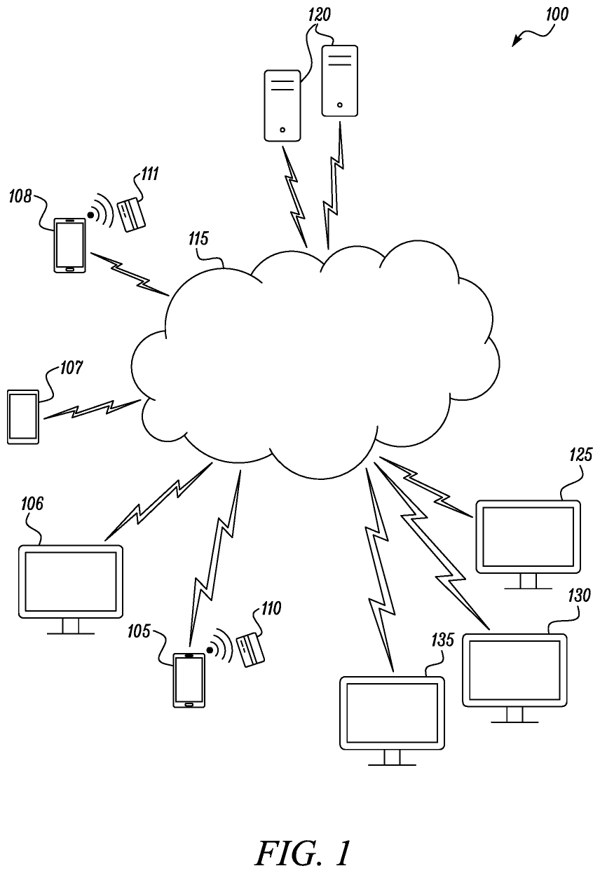

Referring to FIG. 1, a schematic illustration of an environment 100 is disclosed. The environment 100 includes a first electronic device 105 of a user, herein referred to as “user mobile device 105”, and a second electronic device 106 of the user, herein referred to as “personal computer 106”. The environment 100 also includes a third electronic device 107 of a beneficiary, herein referred to as “beneficiary device 107” and a fourth NFC-enabled electronic device 108 of an assignee, herein referred to as “assignee mobile device 108”. The electronic devices 105, 106, 107, 108 may be configured to be in communication with a transaction server 120 via a network 115. Examples of electronic devices 105, 106, 107, 108 and/or the transaction server 120 include, but are not limited to, computers, laptops, mobile devices, handheld devices, personal digital assistants (PDAs), tablet personal computers, digital notebook, automatic teller machines (ATMs), wearables, and similar electronic devices. The network 115 may include communication networks such as, but not limited to, a Local Area Network (LAN), a Wireless Local Area Network (WLAN), a Wide Area Network (WAN), internet and a Small Area Network (SAN). In some embodiments, the network 115 may correspond to telecom networks using EDGE/GPRS/3G/4G/5G technologies.

In some embodiments, the user mobile device 105 may be a Near Field Communication (NFC)-enabled mobile device of a user. It may be noted that the user mobile device 105 is not a point-of-sale (POS) device or a mobile POS device such as those operated by a merchant. The user mobile device 105 may have one or more applications installed or stored in the user mobile device 105. The applications may include system applications that may be pre-installed by a device manufacturer and/or installed applications that may downloaded from an application distribution platform and/or installed by the user in the user mobile device 105 via the network 115. Examples of the applications include, but are not limited to, merchant applications, ecommerce applications, financial applications such as banking applications and/or payment or fund transfer applications, travel, transit tickets and toll applications, donation collection applications, loyalty applications and service provider applications such as, short service message (SMS), email, and/or push notifications, that facilitate and/or aid financial transactions. Further, the user mobile device 105 may be configured to enable an NFC transaction using an NFC-enabled card 110, herein referred as “NFC card 110”, of the user in response to a financial transaction initiated in an application. The NFC card 110 may be a physical NFC-enabled card, a virtual NFC card stored in the user mobile device 105, or an NFC tag included in wearables such as a wristband or a watch. Examples of the financial transaction may include, but not limited to, a purchase transaction, a pre-authorization transaction, a card validity check transaction, and/or a fund transfer transaction initiated by the user in the application. The user mobile device 105 may be configured to receive recipient information of a recipient and retrieve card details of the NFC card 110 when the NFC card 110 is used in conjunction with the user mobile device 105. For example, the user mobile device 105 may be configured to retrieve the card details when the NFC card 110 is within a pre-defined physical proximity range with the user mobile device 105. In another example, the user mobile device 105 may be configured to retrieve the card details from the virtual NFC card stored in the user mobile device 105. Example of the card details retrieved include, but are not limited to, a name on card, card number, expiry date, card verification value, and a name of card processor. In some embodiments, user mobile device 105 may be configured to retrieve only the card number and/or the name of the card processor. In some embodiments, user mobile device 105 may be configured to receive recipient information of the recipient and retrieve the card details simultaneously. In yet another example, the user mobile device 105 may be configured to retrieve the card details including only the card number and/or the name of the card processor. The user mobile device 105 may then be configured to receive the name on card, the card number, the expiry date, the card verification value, and/or the one-time password (OTP) as provided by the user. Exemplarily, the user may provide the additional card details via one or more input means. Examples of the input means include, but are not limited to, manual input, voice commands, scanned input, image or video input, visual commands, and gesture commands.

In one embodiment, the recipient may be a merchant from whom the user buys goods and/or services and makes the purchase transaction via the application that may be a merchant application installed in the user mobile device 105. For instances when the recipient is the merchant, examples of the recipient information include, but are not limited to, merchant name, merchant ID, invoice amount, merchant account details. In another embodiment, the recipient may be the beneficiary of the fund transfer transaction initiated by the user. For instances when the recipient is the beneficiary, examples of the recipient information include, but are not limited to, name of the beneficiary, beneficiary account details, and fund transfer amount. In a first embodiment, the user may initiate the fund transfer transaction from a user financial account to a beneficiary financial account, via the application, that may be a financial application installed in the user mobile device 105. The user may provide the recipient information of the beneficiary in the application in order to initiate the NFC transaction from the user to the beneficiary via the application using the NFC card 110 of the user. Exemplarily, the user may provide the recipient information via one or more input means. Examples of the input means include, but are not limited to, manual input, voice commands, scanned input, image or video input, visual commands, and gesture commands. In a second embodiment, the beneficiary may also request the user to make the fund transfer transaction by providing an NFC transaction request from the beneficiary device 107 to the user mobile device 105 via the network 115 as an alert, such as an SMS, email, and/or a push notification. The NFC transaction request may include an NFC transaction link which, when clicked or selected by the user, may enable the user to initiate the NFC transaction from the user to the beneficiary on the user mobile device 105 using the user's NFC card 110 and/or the application. In some embodiments, the NFC transaction link sent by the beneficiary may also include the recipient information of the beneficiary.

In some embodiments, the user may also request the assignee to initiate the NFC transaction, on behalf of the user, to the recipient, such as the merchant, by providing the NFC transaction request from the user mobile device 105 to the assignee mobile device 108 via the network 115 as an alert, such as, but not limited to, the SMS, email, and/or the push notification. The NFC transaction request may include an NFC transaction link which, when clicked or selected by the assignee, may enable the assignee to initiate the NFC transaction to the recipient, on behalf of the user, using the assignee mobile device 108. The assignee may use an NFC card 111 and/or an application installed in the assignee mobile device 108 in order to initiate the NFC transaction to the recipient. The assignee's NFC card 111 may be similar to the user's NFC card 110. The assignee's NFC card 111 and the user's NFC card 110 will herein be understood as being configured to have similar components that perform similar functions. In some embodiments, the NFC transaction request sent by the user to the assignee may also include the recipient information of the recipient.

In some embodiments, the personal computer 106 of the user may be in communication with the internet via the network 115. The personal computer 106 may enable the user to make the financial transaction via one or more financial websites on the internet. In one embodiment, personal computer 106 may enable the user to make the purchase transaction via a merchant website on the internet. In an embodiment, the user may optionally choose to complete the purchase transaction initiated on the personal computer 106 using the user mobile device 105 via the merchant website. The user may provide user details, such as, but not limited to, a phone number or a device ID associated with the user mobile device 105, or an email associated with the user in the merchant website. In some embodiments, the user details may also be prestored in the personal computer 106 and may automatically be provided in the merchant website. Based on the user details received by the merchant website, the merchant website may in turn trigger an NFC transaction request to be sent to the user mobile device 105. The user mobile device 105 may be configured to receive the NFC transaction request from the transaction server 120 in response to the purchase transaction initiated by the user on the merchant website using the personal computer 106. The user mobile device 105 may receive the NFC transaction request via the SMS, email, and/or the push notification. The NFC transaction request received from the transaction server 120 may include an NFC transaction link which, when interacted with by the user, such as by clicking or selecting the NFC transaction link, enables the user to initiate the NFC transaction from the user to the merchant on the user mobile device 105 using the NFC card 110. In another embodiment, the personal computer 106 may enable the user to make the fund transfer transaction to the beneficiary via a financial website on the internet. The user mobile device 105 may be configured to receive the NFC transaction request via SMS, email, and/or the push notification from the transaction server 120 in response to the fund transfer transaction initiated by the user on the financial website using the personal computer 106. The NFC transaction request received from the transaction server 120 may include an NFC transaction link which, when clicked or selected by the user, enables the user to initiate the NFC transaction from the user to the beneficiary on the user mobile device 105 using the NFC card 110.

In some embodiments, the user mobile device 105 may be configured to relay the recipient information and the card details to the transaction server 120 via the network 115 in order to initiate the NFC transaction. The transaction server 120 may in turn be configured to direct transaction details including the recipient information and the card details received via the user mobile device 105 to an acquirer 125, a transaction processor 130, or an issuer 135 based on the recipient information, for example, the merchant ID or the beneficiary account details. The acquirer 125 may be an acquiring bank of the merchant. The issuer 135 may be an issuing bank of the user. The transaction processor 130 may be a card network such as Mastercard® or Visa®. In some embodiments, the transaction server 120 may validate the recipient based on the recipient information prior to providing the transaction details to the acquirer 125, the transaction processor 130, or the issuer 135. The transaction server 120 may also be configured to provide alerts such as an SMS, email, or a push notification to the user mobile device 105 and/or to the application in the user mobile device 105 directly with instructions to accept or decline the NFC transaction initiated by the user based on the validation of the recipient, the recipient information, and/or the card details. In some embodiments, for instances when there is a predefined time delay in responding or when the user fails to respond to the alerts to the alert received on the user mobile device 105, the transaction server 120 may be configured to automatically disable and/or decline the NFC transaction.

For instances when the transaction server 120 provides the transaction details to the acquirer 125, the acquirer 125 may in turn communicate with the transaction processor 130 and/or an issuer 135 via the network 115 to process the financial transaction. For instances when the transaction server 120 provides the transaction details to the transaction processor 130, the transaction processor 130 may in turn communicate with the acquirer 125 and/or an issuer 135 via the network 115 to process the financial transaction. For instances when the transaction server 120 provides the transaction details directly to the issuer 135, the issuer 135 may in turn communicate with the transaction processor 130 and/or the acquirer 125 via the network 115 to process the fund transfer transaction initiated by the user. In some embodiments, the acquirer 125, the transaction processor 130, and/or the issuer 135 may provide a status notification of the financial transaction to the transaction server 120. The status notification may indicate a success or a failure of the financial transaction and optionally also provide additional information, such as, but not limited to, reasons for failure, success message, and transaction details and/or receipt. The transaction server 120 may in turn provide the status notification to the user mobile device 105 via as the SMS, email, and/or the push notification. The transaction server 120 may also be configured to provide the additional information along the status notification to the user mobile device 105. In some embodiments, the transaction server 120 may be configured to customize the additional information and/or also provide supplementary information to the user mobile device 105 based on the status notification received. The user mobile device 105 may also be configured to receive the status notification including transaction details and/or a transaction receipt from the transaction server 120 and provide the status notification to the application in the user mobile device 105.

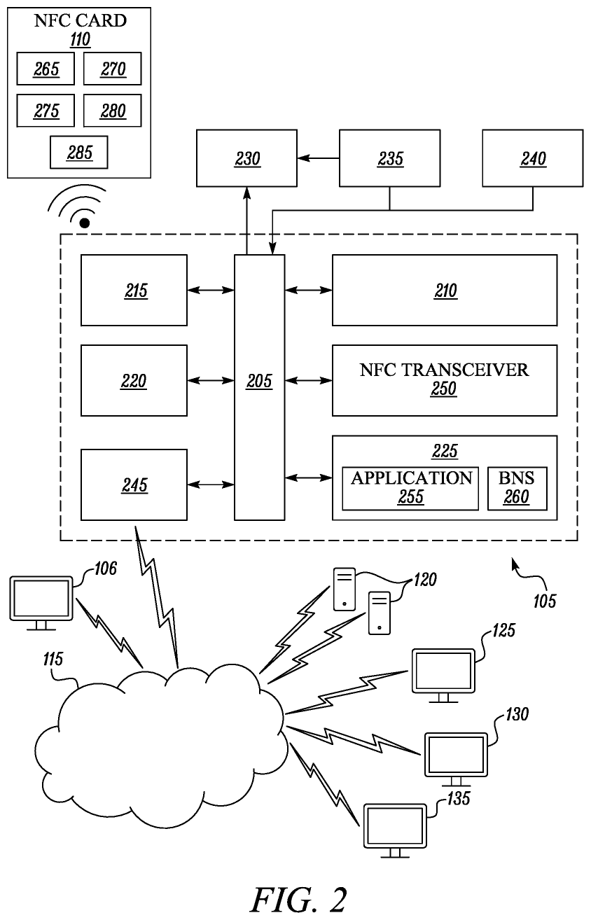

Referring to FIG. 2, a block diagram of the user mobile device 105 of FIG. 1 is disclosed. In some embodiments, the user mobile device 105 includes a bus 205 or other communication mechanism for communicating information, and a processor 210 coupled with the bus 205 for processing information. The user mobile device 105 also includes a memory 215, such as a random-access memory (RAM) or other dynamic storage device, coupled to the bus 205 for storing information and instructions to be executed by the processor 210. The memory 215 can be used for storing temporary variables or other intermediate information during execution of instructions to be executed by the processor 210. The user mobile device 105 further includes a read only memory (ROM) 220 or other static storage device coupled to bus 205 for storing static information and instructions for processor 210. A storage unit 225, such as a magnetic disk, optical disk, solid state or semiconductor memory, is provided and coupled to the bus 205. The storage unit 225 may store one or more applications 255 and a background NFC service (BNS) 260. The storage unit 225 may also store firmware, Original Equipment Manufacturer (OEM) applications, and an operating system (OS) related files and data. The applications 255 and the BNS 260 may be downloaded and installed in the user mobile device 105 via various application distribution platforms or may also be pre-installed in the user mobile device 105. In some embodiments, the BNS 260 may be installed or stored at an instance of the download and installation of an application 255 in the user mobile device 105 simultaneously. In another embodiment, the BNS 260 may also be configured to run on the user mobile device 105 at a platform-level, such as, in an operating system of user mobile device 105. The BNS 260 may be also be provided as a part of the operating system of the user mobile device 105 without a user interface. Examples of the operating system include, but are not limited to, Android and iOS. In another embodiment, the BNS 260 in the user mobile device 105 may be pre-installed by a manufacturer of the user mobile device 105. In yet another embodiment, the application 255 may include the BNS 260 as a component and/or a feature of the application 255. In some embodiments, the storage unit 225 may also store details regarding the NFC card 110 in a form of a virtual NFC card. Similarly, the storage unit 225 may also store multiple virtual NFC cards associated with the user.

The user mobile device 105 can be coupled via the bus 205 to a display 230, such as a cathode ray tube (CRT), liquid crystal display (LCD), Light Emitting Diode (LED), and Organic LED (OLED), for displaying information to the user. An input device 235, including alphanumeric and other keys, is coupled to bus 205 for communicating information and command selections to the processor 210. Another type of user input device is a cursor control 240, such as a mouse, a trackball, or cursor direction keys for communicating direction information and command selections to the processor 210 and for controlling cursor movement on the display 230. The input device 235 can also be included in the display 230, for example a touch screen.

Various embodiments are related to the use of user mobile device 105 for implementing the techniques described herein. In one embodiment, the techniques are performed by the user mobile device 105 in response to the processor 210 executing instructions included in the memory 215. Such instructions can be read into the memory 215 from another machine-readable medium, such as the storage unit 225. Execution of the instructions included in the memory 215 causes the processor 210 to perform the process steps described herein.

The term “machine-readable medium” as used herein refers to any medium that participates in providing data that causes a machine to operate in a specific fashion. In some embodiments implemented using the user mobile device 105, various machine-readable media are involved, for example, in providing instructions to the processor 210 for execution. The machine-readable medium can be a storage media. Storage media includes both non-volatile media and volatile media. Non-volatile media includes, for example, optical or magnetic disks, such as storage unit 225. Volatile media includes dynamic memory, such as the memory 215. All such media must be tangible to enable the instructions carried by the media to be detected by a physical mechanism that reads the instructions into a machine.

Common forms of machine-readable medium include, for example, a floppy disk, a flexible disk, hard disk, magnetic tape, or any other magnetic medium, a CD-ROM, any other optical medium, punch cards, paper-tape, any other physical medium with patterns of holes, a RAM, a PROM, and EPROM, a FLASH-EPROM, any other memory chip or cartridge.

In another embodiment, the machine-readable medium can be a transmission media including coaxial cables, copper wire and fibre optics, including the wires that comprise the bus 205. Transmission media can also take the form of acoustic or light waves, such as those generated during radio-wave and infra-red data communications. Examples of machine-readable medium may include but are not limited to a carrier wave as describer hereinafter or any other medium from which the user mobile device 105 can read, for example online software, download links, installation links, and online links. For example, the instructions can initially be carried on a magnetic disk of a remote computer. The remote computer can load the instructions into its dynamic memory and provide the instructions over a telephone line using a modem. A modem local to the user mobile device 105 can receive the data on the telephone line and use an infra-red transmitter to convert the data to an infra-red signal. An infra-red detector can receive the data carried in the infra-red signal and appropriate circuitry can place the data on the bus 205. The bus 205 carries the data to the memory 215, from which the processor 210 retrieves and executes the instructions. The instructions received by the memory 215 can optionally be stored on storage unit 225 either before or after execution by the processor 210. All such media must be tangible to enable the instructions carried by the media to be detected by a physical mechanism that reads the instructions into a machine.

The user mobile device 105 also includes a communication interface 245 coupled to the bus 205. The communication interface 245 provides a two-way data communication coupling to the network 115. For example, the communication interface 245 can be an integrated service digital network (ISDN) card or a modem to provide a data communication connection to a corresponding type of telephone line. As another example, the communication interface 245 can be a local area network (LAN) card to provide a data communication connection to a compatible LAN. Wireless links can also be implemented. In any such implementation, the communication interface 245 sends and receives electrical, electromagnetic or optical signals that carry digital data streams representing various types of information.

In some embodiments, the user mobile device 105 may include an NFC transceiver 250 comprising one or more hardware and software components that facilitate an NFC-enabled interaction between the user mobile device 105 and other NFC-enabled electronic devices such as, but not limited to, smart cards, NFC chip cards, NFC-enabled mobile phones, laptops, wearable, electronic tablets, and desktops. In some embodiments, the NFC transceiver 250 may include an NFC chip and an NFC antenna configured to transmit and receive NFC signals. In yet another embodiment, the NFC transceiver 250 may include separate NFC receiver and transmitter components coupled with respect to each other. In an embodiment, The NFC transceiver 250 may facilitate the NFC-enabled interaction between the user mobile device 105 and the NFC card 110. In some embodiments, the NFC card 110 may also include a memory 265, a central processing unit 270, a power source 275, an NFC chip 280, and an antenna 285. In some embodiments, the NFC card 110 may also include a display unit (not shown). The antenna 285 of the NFC card 110 may utilize power from the power source 275 in order to activate the NFC chip 280. The NFC chip 280 may implement an NFC protocol that facilitates the NFC-enabled interaction with the user mobile device 105. In some embodiments, the NFC card 110 may also be a passive device that includes only the NFC chip 280 and the antenna 285. For instances when the NFC card 110 is a passive device, the NFC card 110 may rely on the user mobile device 105 to trigger or facilitate the NFC-enabled interaction therebetween.

In some embodiments, the processor 210 of the user mobile device 105 may be capable of executing the one or more predefined computer instructions in order to perform one or more functions. The processor 210 may include different hardware and software components that facilitate the performing of the one or more functions. In some embodiments, the processor 210 may be configured to run or execute the application 255, the BNS 260, and one or more modules, such as modules 305-310 and modules 315-325 of the application 255 and the BNS 260, respectively. In some embodiments, the processor 210 may be configured to run or execute the BNS 260 and the modules 315-325 of the BNS 260 as a background process at a platform-level in the user mobile device 105. The processor 210 may be configured to run the BNS 260 such that the BNS 260 has no user interface, and is not directly activated, interacted with, or engaged by the user, and functions performed by the BNS 260 are not evident to the user. For example, the processor 210 may be configured to run or execute the BNS 260 and the modules 315-325 of the BNS 260 as a background process or service in an Android Operating System platform such that operations of the BNS 260 and the modules 315-325 are not evident to the user.

The processor 210 may also be configured to facilitate inter-communication between the application 255 and the BNS 260 via service calls. Examples of the service calls include, but are not limited to, local notifications, local asynchronous messaging objects, remote procedure calls (RPCs), operating system calls, integration capable libraries, calls made using software development kits (SDKs), remote push notifications, and scheduled local notifications. The service calls may be platform-level features or objects that may be implemented by the application 255 and/or the BNS 260 to communicate with and/or activate or invoke each other. Examples of a local asynchronous messaging object may include, but not limited to, an “Intent” in an Android operating system environment, herein referred to as “Android Intent”. The Android Intent is the message or the local asynchronous messaging object that is passed between components such as applications, activities, content providers, broadcast receivers, and services, including background services, in the user mobile device 105. The Android Intent may be an implicit intent that may not specify the component(s) to which the message is to be passed, or an explicit intent that specifies the component to which the message is to be passed. In one embodiment, the application 255 may be configured to provide the explicit intent to the BNS 260 in order to communicate with and/or activate or invoke the BNS 260 and vice versa. In another embodiment, for instances when the BNS 260 is incorporated in the application 255, the application 255 may be configured to provide the implicit intent to the BNS 260 in order to communicate with and/or activate or invoke the BNS 260 and vice versa.

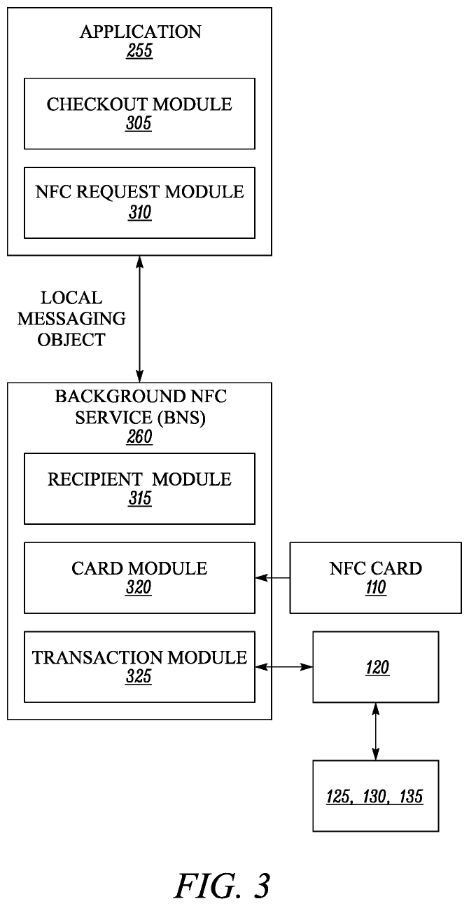

Referring to FIG. 3, a schematic block diagram of the one or more modules (305-310) and (315-325) in the application 255 and the background NFC Payment Service (BNS) 260 respectively in the user mobile device 105 of FIG. 1 is disclosed.

In one embodiment, the application 255 in the user mobile device 105 may enable the user to initiate an NFC transaction from the user to a recipient such as a merchant or a beneficiary. The application 255 may include a checkout module 305 that facilitates a user to initiate a financial transaction in the application 255. Further, the application 255 may include an NFC request module 310 that is configured to send and receive a service call, for example, a local messaging object, to and from the BNS 260 respectively.

The checkout module 305 may configured to present one or more checkout methods to the user in the application 255 via a user interface of the application 255. In some embodiments, the checkout module 305 may be configured to display a shopping cart to the user on the user interface of the application 255. The checkout module 305 may then be configured to enable the user to make a purchase transaction from the shopping cart and present the checkout methods. Examples of the checkout methods include, but are not limited to, net banking, debit or credit magnetic strip card transaction, chip card transaction, Unified Payment Interface (UPI) transaction, NFC transaction using cards or other transaction methods, wallet transactions, prepaid card transactions, and toll tags. Upon selection of an NFC transaction option or NFC card checkout method by the user, the checkout module 305 may activate with the NFC request module 310.

The NFC request module 310 may provide the local messaging object to the BNS 260 requesting the BNS 260 to facilitate the NFC card checkout method. In some embodiments, the NFC request module 310 may be configured to display a prompt via visual and/or auditory means such as, but not limited to, a pop-up in the user interface of the application 255 or the user mobile device 105 indicating to the user to use the NFC card 110 in conjunction with the user mobile device 105. For example, the NFC request module 310 may display the pop-up indicating to the user to bring the NFC card 110 in the predefined proximity to the user mobile device 105 or use a virtual NFC card stored in the storage unit 225. NFC request module 310 may also include a recipient information in the local messaging object. The recipient information may include, but not limited to, a merchant name, a merchant ID, an invoice amount, merchant account details, recipient account details, and/or recipient name, associated with the financial transaction initiated by the user. The BNS 260 may be configured to receive the local messaging object from the NFC request module 310 of the application 255. In some embodiments, the BNS 260 may be configured to triggered only in response to receiving the service call, such as the local messaging object, from the application 255 and/or other applications in the user mobile device 105.

In another embodiment, the user may initiate the financial transaction using the personal computer 106 (see FIG. 1) via one or more financial websites on the internet and optionally choose the NFC transaction option or the NFC checkout method to complete the financial transaction. The user may also indicate or place a request in the financial website to complete the financial transaction using the user mobile device 105 by providing user details such as, but not limited to, a phone number or a device ID associated with the user mobile device 105 or an email associated with the user. In some embodiments, the user details may also be prestored in the personal computer 106 and may automatically be provided in the merchant website. The financial website may in turn trigger the NFC transaction request to be provided to the transaction server 120. The transaction server 120 may be configured to receive an NFC transaction request from the financial website and based on the user details, provide an alert, such as a short message service (SMS), an email and/or a push notification, including an NFC transaction link to the user mobile device 105. The BNS 260 may be configured to facilitate the NFC checkout method or the NFC transaction option in response to the NFC transaction link being clicked or selected by the user.

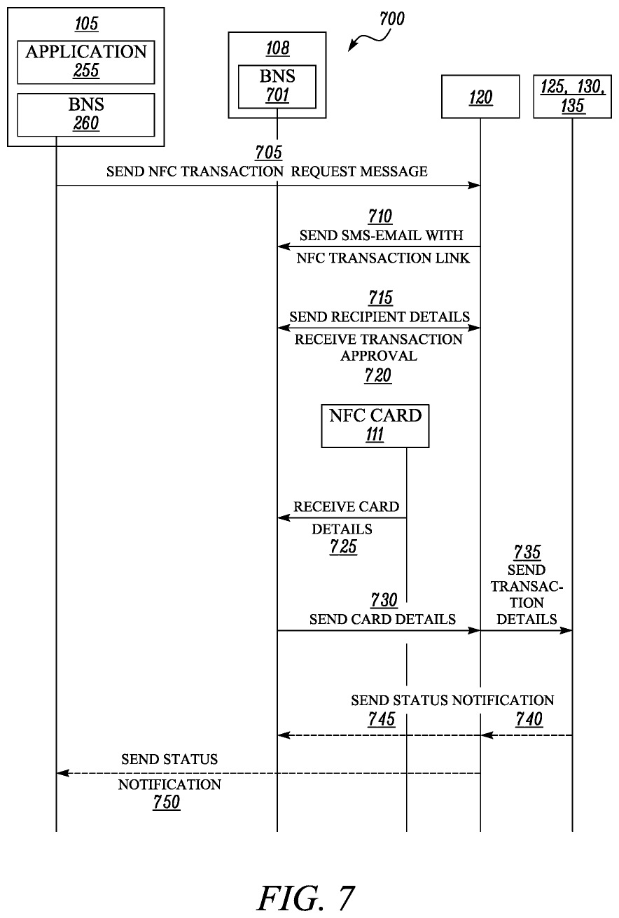

In yet another embodiment, the NFC request module 310 may be configured to allow the user to request an assignee to initiate the NFC transaction from the user to the recipient on behalf of the user. In some embodiments, the NFC request module 310 may also be configured to enable the user to provide assignee details, such as, a name of the assignee and contact details of the assignee, such as a phone number or an email. Exemplarily, the user may provide the assignee details via one or more input means. Examples of the input means include, but are not limited to, manual input, voice commands, scanned input, image or video input, visual commands, and gesture commands. Further, based on the assignee details, the NFC request module 310 may also be configured to provide the NFC transaction request via the SMS, email, and/or the push notification to the assignee mobile device 108 (see FIG. 1) in response to the user's request. The NFC transaction request may include an NFC transaction link which, when interacted with by the assignee on the assignee mobile device 108, may enable the assignee to initiate the NFC transaction from the user to the recipient on behalf of the user. In some embodiments, the NFC transaction link provided by the user to the assignee may include the recipient information of the recipient. The assignee mobile device 108 may also include a BNS, for example, BNS 701 (see FIG. 7), that is similar to the BNS 260 of the user mobile device 105 and may be configured to facilitate the NFC transaction in response to the NFC transaction link being interacted with by the assignee on the assignee mobile device 108. The BNS in the assignee mobile device 108 may be configured to enable the assignee to use the NFC card 111 (see FIG. 1) of the assignee and/or an application installed in the assignee mobile device 108 in order to initiate the NFC transaction from the user to the recipient. The BNS in the assignee mobile device 108 and the BNS 260 in the user mobile device 105 will herein be understood as being configured to have similar components that perform similar functions.

The BNS 260 may include a recipient module 315 to receive recipient information, a card module 320, and a transaction module 325. In one embodiment, the recipient module 315 may receive the recipient information from the application 255 when the financial transaction is initiated by the user in the application 255. In another embodiment, the recipient module 315 may receive the recipient information via the SMS, email, and/or the push notification from the transaction server 120 when the financial transaction is initiated by the user using the personal computer 106. In some embodiments, the recipient module 315 may provide a request for authorization, validation, and/or verification of the recipient request along with the recipient information, for example, the merchant ID (MID) to the transaction server 120. The transaction server 120 may in turn validate, verify, and/or authenticate the recipient based on the recipient information received from the recipient module 315. The transaction server 120 may then provide validation status that includes an authorization instruction to the recipient module 315 based on the verification via the network 115 (see FIG. 1). For example, when the recipient is validated and/or verified, the transaction server 120 may instruct the recipient module 315 to accept the NFC transaction request from the NFC request module 310 or from the SMS, email, and/or the push notification link via the authorization instruction in the validation status. Similarly, when the recipient is not validated or verified, the transaction server 120 may instruct the recipient module 315 to reject the NFC transaction request from the NFC request module 310 or from the SMS, email, and/or the push notification link via the authorization instruction in the validation status. The recipient module 315 may in turn activate the card module 320 or present a transaction failure message on the user mobile device 105 via the display 230 (see FIG. 2) based on the validation status. In another embodiment, the recipient module 315 may activate the card module 320 directly without providing the recipient information for verification and/or authentication.

The card module 320 may be configured to retrieve card details of the NFC card 110 (also see FIG. 1) when the NFC card 110 is used in conjunction with the user mobile device 105 via the NFC transceiver 250. In some embodiments, the card module 320 may correspond to a software kernel certified by the transaction processor 130. For example, the card module 320 may be EMV certified in order to retrieve the card details of the user. In some embodiments, the card module 320 may be configured to display a prompt via visual and/or auditory means, such as, but not limited to, a pop-up in the user interface of the application 255 or the user mobile device 105, indicating to the user to bring the NFC card 110 in the predefined proximity to the user mobile device 105. In another embodiment, the card module 320 may also be configured to send a service call, such as a local asynchronous messaging object, to the application 255 in order to retrieve the card details. The application 255 may, in turn, be configured to present the prompt on the user interface of the application 255. The card module 320 may be configured to retrieve card details of the NFC card 110 when the NFC card 110 is within a pre-defined physical proximity range with the user mobile device 105. The pre-defined physical proximity range may vary from 0 to 10 centimetres. In another embodiment, the card module 320 may be configured to open a digital wallet or a financial application in the user mobile device 105 and enable the user to select a preferred virtual NFC card from the multiple virtual NFC cards associated with the user. The card module 320 may be configured to retrieve card details from the virtual NFC card selected. Example of the card details retrieved include, but are not limited to, card name, card number, expiry date, and card verification value. In some embodiments, the card module 320 may be configured to retrieve the card details including only the card number and/or the name of the card transaction processor. The card module 320 may then be configured to display a card detail entry form on the user interface of the application 255. The card module 320 may then be configured to receive the name on card, the card number, the expiry date, the card verification value, and/or the one-time password (OTP) as provided by the user. Exemplarily, the user may provide the card details via one or more input means. Examples of the input means include, but are not limited to, manual input, voice commands, scanned input, image or video input, visual commands, and gesture commands. The financial transaction for which the card details are visible to human eye and/or are received manually from the user is referred to a “Card-Not-Present (CNP)” transaction. In some embodiments, the card module 320 may be configured to generate an encrypted string of data, also referred to as a security cryptogram, corresponding to the CNP financial transaction. In another embodiment, the card module 320 may be configured to request and receive the security cryptogram from the NFC card 110 during the CNP transaction.

In some embodiments, the card module 320 may also be configured to retrieve the card details that are invisible to human eye automatically from the NFC card 110. The card module 320 may, thereby, enable a “Card Present” transaction using the user mobile device 105. The “Card Present” transaction corresponds to a transaction in which the transaction processor 130 (also see FIG. 1) receives the card details that are invisible to the human eye such as the encrypted string of data or the security cryptogram. In some embodiments, the card module 320 may also be configured to generate the security cryptogram, corresponding to the CP transaction. In yet another embodiment, the card module 320 may be configured to request and receive the security cryptogram from the NFC card 110 during the CP transaction. Thus, the card module 320 enables the “Card Present” transaction when the user uses the NFC card 110 in conjunction with the user mobile device 105 to initiate the NFC transaction. In some embodiments, the recipient module 315 and the card module 320 may be configured to perform respective functions simultaneously. The recipient module 315 and the card module 320 may also be configured to provide the recipient information, the card details, and the security cryptogram to the transaction module 325.

The transaction module 325 may be configured to provide transaction details including the recipient information and the card details, and the security cryptogram to the transaction server 120 via the network 115 (see FIG. 1). In some embodiments, the Communication module 250 may enable the transaction module 325 to provide an NFC Payment Fulfilment Message via the local messaging object to the NFC request module 310 to indicate a success or failure in enabling the NFC checkout method or the NFC transaction option by the BNS 260. The transaction module 325 may be configured to provide the NFC Payment Fulfilment Message simultaneous to providing the transaction details to the transaction server 120.

In some embodiments, the transaction server 120 may also include the components 205-245 similar to the user mobile device 105. Accordingly, functions performed by the transaction server 120 will herein be understood as functions performed by the processor 210 of the transaction server 120 in order to monitor and attest the NFC transaction. Accordingly, based on the transaction details received from the transaction module 325, the transaction server 120 may in turn provide the transaction details to the acquirer 125, the issuer 135, or the transaction processor 130. In some embodiments, the transaction server 120 may also be configured to provide the security cryptogram, to the acquirer 125, the issuer 135, or the transaction processor 130 in order to validate the “Card Present” (CP) transaction corresponding to the NFC transaction based on the transaction details. In some embodiments, the transaction server 120 may be configured to assign a Proxy Terminal ID (PTID) to the user mobile device 105. In some embodiments, the transaction server 120 may be configured to assign the PTID dynamically to the user mobile device 105. Accordingly, it may be apparent that the transaction server 120 may be configured to dynamically assign multiple PTIDs corresponding to multiple mobile and/or electronic devices associated with other users and/or participants respectively, similar to the PTID assigned to the user mobile device 105 of the user. In some embodiments, the multiple PTIDs assigned to each mobile device of the other users as well as the PTID assigned to the user may be distinct from one another. In some embodiments, the transaction server 120 may assign the PTIDs dynamically using multiple techniques including, but not limited to, using additional information related to the user mobile device 105 such as, but not limited to, a mobile number of the user and a location of the user mobile device 105 detected and/or identified. In another embodiment, the acquirer 125 or the transaction processor 130 may also assign different terminal identifications (TIDs) to the multiple mobile and/or electronic devices and the transaction server 120 may not be configured to implement the dynamic assigning of the PTIDs. In some embodiments, the transaction server 120 may be configured to combine the PTID assigned to the user mobile device 105 with the recipient information, such as the recipient ID, to uniquely identify each recipient identified based on the recipient information received corresponding to each application. Accordingly, the transaction details may include combination of the PTID and the recipient information corresponding to each recipient. The transaction server 120 may, hence, be configured to provide the transaction details including the combination of the PTID and the recipient information and the card details to the the acquirer 125, the issuer 135, or the transaction processor 130.

In one embodiment, the transaction server 120 may provide the transaction details to the acquirer 125 in response to the financial transaction. The acquirer 125 may in turn communicate with the transaction processor 130 and the issuer 135 via the network 115 (see FIG. 1) to process the financial transaction. In another embodiment, the transaction server 120 may provide the transaction details to the transaction processor 130 in response to the financial transaction. The transaction processor 130 may in turn communicate with the acquirer 125 and an issuer 135 via the network 115 to process the financial transaction. In yet another embodiment, the transaction server 120 may provide the transaction details to the issuer 135 in response to the financial transaction. The issuer 135 may in turn communicate with the transaction processor 130 and/or the acquirer 125 via the network 115 to process the financial transaction.

In some embodiments, the transaction server 120 may receive a status notification of the financial transaction from the acquirer 125, the transaction processor 130, or the issuer 135. The status notification may indicate a success or a failure of the financial transaction. The transaction server 120 may in turn provide the status notification to the user mobile device 105 via an SMS, an email, and/or a push notification.

The transaction module 325 of BNS 260 may also be configured to receive the status notification from the transaction server 120. The Communication module 250 may enable the transaction module 325 to in turn provide the status notification to the checkout module 305 of the application 255 via the local messaging object. The checkout module 305 in application 255 may be configured to present a success or failure message to the user based on the success or the failure of the financial transaction as indicated by the status notification received from the BNS 260.

### INDUSTRIAL APPLICABILITY

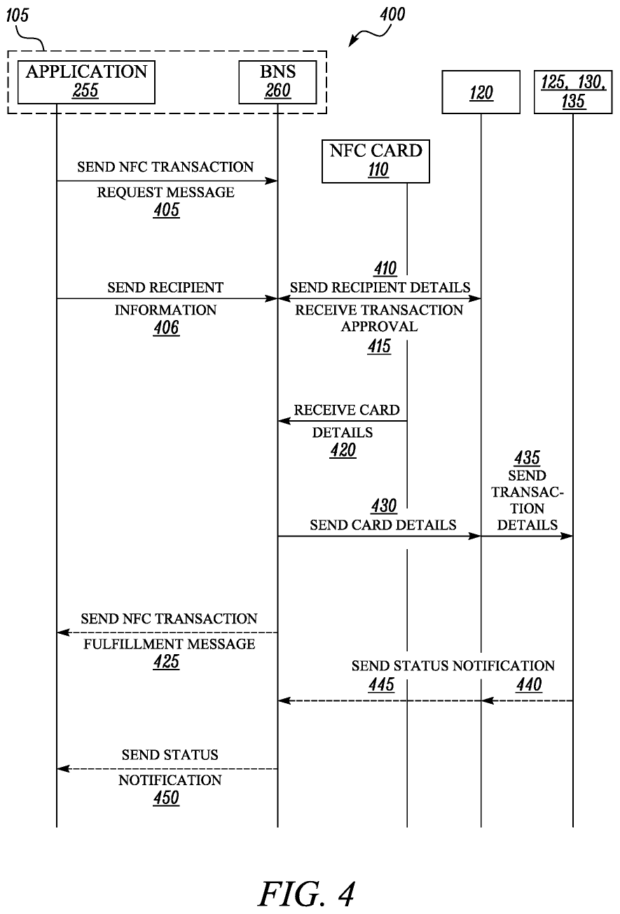

Referring to FIG. 4, an exemplary flow diagram of a method 400 for managing an NFC transaction request raised by the application 255 in the user mobile device 105 of FIG. 1 using the BNS 260 is disclosed. At step 405 and 406, the application 255 may provide an NFC transaction request message to the BNS 260 by means of the service call and also provide the recipient information to the BNS 260 simultaneously to complete a financial transaction. At step 410, the BNS 260 may provide the recipient information to the transaction server 120. At step 415, the transaction server 120 may verify the recipient based on the recipient information and provide a transaction approval to the BNS 260. Based on the transaction approval, at step 420, the BNS 260 may prompt the user, via visual and/or auditory means, to bring the NFC card 110 in predefined proximity to the user mobile device 105. In some embodiments, step 410 and step 415 may be optional and/or omitted and step 420 may be performed without the transaction approval. In some embodiments, the visual prompt may be in the form of a pop-up presented on the user interface of the application 255 or a user interface of the user mobile device 105. In some embodiments, the auditory prompt may be in form of a notification chime provided to the user via output components, such as a speaker, provided in the user mobile device 105. At step 420, the BNS 260 may also receive the card details from the user's NFC card 110. At step 425, the BNS 260 may provide an NFC transaction fulfillment message to the application 255 via the service call. At step 430, the BNS 260 may provide the transaction details including the recipient information and the card details to transaction server 120. In some embodiments, the steps 425 and 430 may be performed simultaneously. Based on the transaction details, at step 435, the transaction server 120 may in turn verify and provide the transaction details to the acquirer 125, the transaction processor 130, or the issuer 135. In some embodiments, at step 435, the transaction server 120 may assign a proxy terminal ID (PTID) to the user mobile device 105 and include the PTID in the transaction details. Further, at step 435, the transaction server 120 may provide the transaction details including the PTID to the acquirer 125, the transaction processor 130, or the issuer 135. At step 440, the acquirer 125, the transaction processor 130, or the issuer 135 may provide a status notification indicating a success or failure of the financial transaction to the transaction server 120. At step 445, the transaction server 120 may in turn provide the status notification including transaction details or a transaction receipt to the BNS 260. At step 450, the BNS 260 may in turn provide the status notification to the application 255 via the service call. The application 255 may then display a success or failure message to the user based on the status notification. The application 255 may also provide the transaction receipt in case of a successful NFC transaction that may be optionally viewed and/or stored in the user mobile device 105 by the user or automatically stored in one or more file formats. Further, in case of a failure of the NFC transaction, application 255 may also provide reasons for the failure to the user via the user interface.

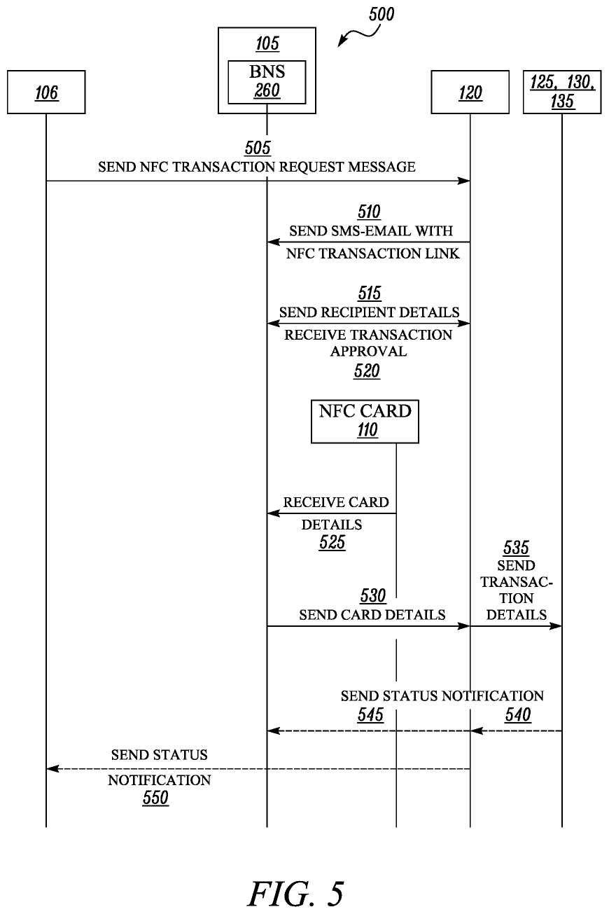

Referring to FIG. 5 an exemplary flow diagram of a method 500 for managing an NFC transaction request initiated by the user using the personal computer 106 of FIG. 1. At step 505, the user may initiate a financial transaction on a financial website using the personal computer 106. Further, at step 505, the user may optionally choose the NFC checkout method or the NFC transaction option to complete the financial transaction. Further, at step 505, the user may indicate or place a request in the financial website to complete the financial transaction using the user mobile device 105 by providing user details such as, but not limited to, a phone number or a device ID associated with the user mobile device 105 or an email associated with the user. In some embodiments, the user details may also be prestored in the personal computer 106 and may automatically be provided in the financial website. In addition, at step 505, the financial website may in turn provide an NFC transaction request together with the user details to the transaction server 120 in response the financial transaction initiated by the user. In some embodiments, at step 505, the financial website may also provide a recipient information to the transaction server 120 along with the NFC transaction request. In some embodiments, at step 510, the transaction server 120 may assign a first proxy terminal ID (PTID) to the personal computer 106. Further, at step 510, based on the user details received, the transaction server 120 may provide an NFC transaction request including an NFC transaction link via an SMS, email, and/or a push notification to the user mobile device 105 in order to initiate the NFC transaction. At step 515, in response to the user clicking on or selecting the NFC transaction link, the BNS 260 may in turn provide the recipient information to the transaction server 120. At step 520, the transaction server 120 may verify the recipient based on the recipient information and provide a transaction approval to the BNS 260. Based on the transaction approval, at step 525, the BNS 260 may prompt, such as by visual and/or auditory means, the user to bring the NFC card 110 in predefined proximity to the user mobile device 105. In some embodiments, step 515 and step 520 may be optional and/or omitted and step 525 may be performed without the transaction approval. In some embodiments, the prompt may be in the form of a pop-up presented on the user interface of the application 255 or the user mobile device 105. At step 525, the BNS 260 may also receive the card details from the user's NFC card 110. At step 530, the BNS 260 may provide the transaction details including the recipient information and the card details to transaction server 120. Based on the transaction details, at step 535, the transaction server 120 may in turn verify and provide the transaction details to the acquirer 125, the transaction processor 130, or the issuer 135. In some embodiments, at step 535, the transaction server 120 may assign a second PTID to the user mobile device 105 and include the second PTID in the transaction details. Further, at step 535, the transaction server 120 may provide the transaction details including the PTID to the acquirer 125, the transaction processor 130, or the issuer 135. At step 540, the acquirer 125, the transaction processor 130, or the issuer 135 may provide a status notification indicating a success or failure of the financial transaction to the transaction server 120. At step 545, the transaction server 120 may in turn provide the status notification including transaction details and/or a transaction receipt to the BNS 260. The BNS 260 may then display a success or failure message to the user on the user mobile device 105 based on the status notification. The BNS 260 may also provide the transaction receipt in case of a successful NFC transaction that may be optionally viewed and/or stored in the user mobile device 105 by the user or automatically stored in one or more file formats. Further, in case of a failure of the NFC transaction, the BNS 260 may also provide reasons for the failure to the user via the user interface. At step 550, the transaction server 120 may also provide the status notification including transaction details and/or a transaction receipt to the financial website and may in turn display a success or failure message to the user on the personal computer 106 based on the status notification. In some embodiments, the steps 545 and 550 may be performed simultaneously.

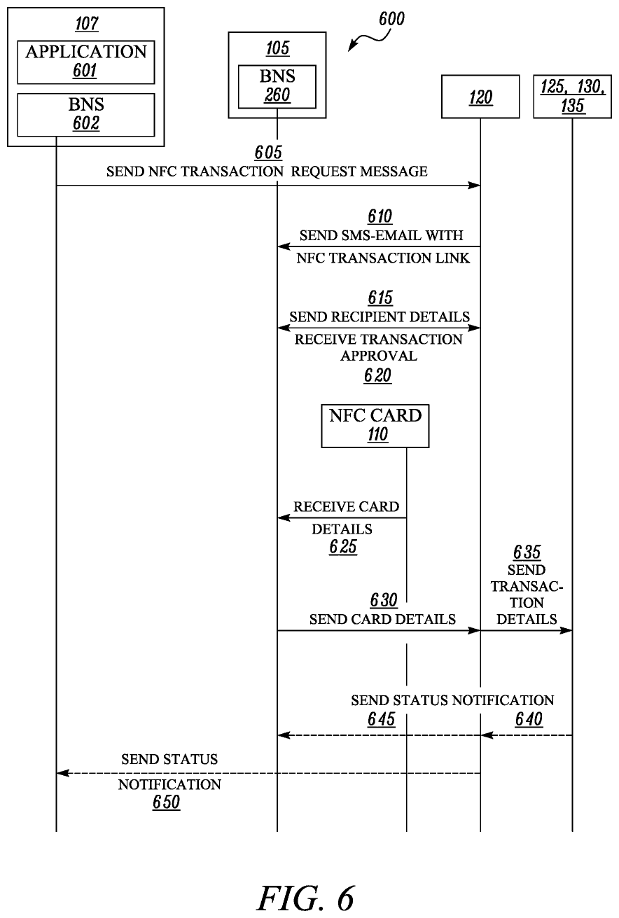

Referring to FIG. 6 an exemplary flow diagram of a method for managing an NFC transaction request sent by the beneficiary device 107 of FIG. 1 to the user mobile device 105 of FIG. 1 is disclosed. In some embodiments, the beneficiary may also be a recipient, such as merchant, requesting the user to initiate an NFC transaction. At step 605, the beneficiary may initiate a financial transaction on an application 601 in the beneficiary device 107 in order to request the user to initiate the NFC transaction. Further, at step 605, the beneficiary may place the request in the application 601 by providing user details such as, but not limited to, a phone number or a device ID associated with the user mobile device 105 or an email associated with the user. In some embodiments, the user details may also be prestored in the beneficiary device 107 and may automatically be provided in the application 601. Further, at step 605, the application 601 may in turn provide an NFC transaction request together with the user details to the transaction server 120 in response the financial transaction initiated by the beneficiary. In some embodiments, the application 601 may provide the NFC transaction request including a recipient information to a BNS 602 provided in the beneficiary device 107. The BNS 602 in the beneficiary device 107 may in turn provide the NFC transaction request to the transaction server 120. In some embodiments, at step 605, the application 601 and/or the BNS 602 may also provide the recipient information of the beneficiary to the transaction server 120 along with the NFC transaction request. At step 610, based on the user details, the transaction server 120 may provide the NFC transaction request including an NFC transaction link via an SMS, email, and/or a push notification to the user mobile device 105 in order to complete the NFC transaction from the user to the beneficiary. At step 615, in response to the user interacting with the NFC transaction link, the BNS 260 may in turn provide the recipient information to the transaction server 120. At step 620, the transaction server 120 may verify the recipient based on the recipient information and provide a transaction approval to the BNS 260. Based on the transaction approval, at step 625, the BNS 260 may prompt the user via visual and/or auditory means to bring the NFC card 110 in predefined proximity to the user mobile device 105. In some embodiments, step 615 and step 620 may be optional and/or omitted and step 625 may be performed without the transaction approval. At step 625, the BNS 260 may also receive the card details from the user's NFC card 110. At step 630, the BNS 260 may provide the transaction details including the recipient information and the card details to transaction server 120. Based on the transaction details, at step 635, the transaction server 120 may in turn verify and provide the transaction details to the acquirer 125, the transaction processor 130, or the issuer 135. In some embodiments, at step 635, the transaction server 120 may assign a proxy terminal ID (PTID) to the user mobile device 105 and include the PTID in the transaction details. Further, at step 635, the transaction server 120 may provide the transaction details including the PTID to the acquirer 125, the transaction processor 130, or the issuer 135. At step 640, the acquirer 125, the transaction processor 130, or the issuer 135 may provide a status notification indicating a success or failure of the financial transaction to the transaction server 120. At step 645, the transaction server 120 may in turn provide the status notification including transaction details and/or a transaction receipt to the BNS 260. The BNS 260 may then display a success or failure message to the user on the user mobile device 105 based on the status notification. The BNS 260 may also provide the transaction receipt in case of a successful NFC transaction that may be optionally viewed and/or stored in the user mobile device 105 by the user or automatically stored in one or more file formats. Further, in case of a failure of the NFC transaction, the BNS 260 may also provide reasons for the failure to the user via the user interface. At step 650, the transaction server 120 may also provide the status notification including transaction details and/or a transaction receipt to the application 601 via the BNS 602 that may in turn display a success or failure message to the beneficiary on the beneficiary device 107 based on the status notification. The application 601 may also provide the transaction receipt in case of a successful NFC transaction that may be optionally viewed and/or stored in the beneficiary device 107 by the beneficiary or automatically stored in one or more file formats. Further, in case of a failure of the NFC transaction, application 601 may also provide reasons for the failure to the beneficiary via the user interface. In some embodiments, the steps 645 and 650 may be performed simultaneously.

Referring to FIG. 7 an exemplary flow diagram of a method for managing an NFC transaction request sent by a user using the user mobile device 105 of FIG. 1 to the assignee mobile device 108 of FIG. 1 is disclosed. At step 705, the user may initiate a financial transaction requesting the assignee to initiate the NFC transaction on behalf of the user using the application 255 in the user mobile device 105. Further, at step 705, the user may place the request in the application 255 by providing assignee details such as, but not limited to, a phone number or a device ID associated with the assignee mobile device 108 or an email associated with the assignee. In some embodiments, the assignee details may also be prestored in the user mobile device 105 and may automatically be provided in the application 255. Further, at step 705, the application 255 may provide an NFC transaction request including a recipient information and the assignee details to the BNS 260 in response the financial transaction initiated by the user. The BNS 260 may in turn provide the NFC transaction request and the assignee details to the transaction server 120. In some embodiments, at step 705, the BNS 260 may provide the recipient information to the transaction server 120 along with the NFC transaction request. In some embodiments, at step 710, the transaction server 120 may assign a first proxy terminal ID (PTID) to the user mobile device 105. Further, at step 710, based on the assignee details, the transaction server 120 may provide an NFC transaction request including an NFC transaction link via an SMS, email, and/or a push notification to the assignee mobile device 108 in order to initiate the NFC transaction. At step 715, in response to the assignee clicking on or selecting the NFC transaction link, a BNS 701 provided in the assignee mobile device 108 may in turn provide the recipient information to the transaction server 120. At step 720, the transaction server 120 may verify the recipient based on the recipient information and provide a transaction approval to the BNS 701 in the assignee mobile device 108. Based on the transaction approval, at step 725, the BNS 701 may prompt the assignee via visual and/or auditory means to bring the NFC card 111 in predefined proximity to the beneficiary device 107. In some embodiments, step 715 and step 720 may be optional and/or omitted and step 725 may be performed without the transaction approval. The visual prompt may be in the form of a pop-up presented on the user interface of the beneficiary device 107. At step 725, the BNS 701 may also receive the card details from the assignee's NFC card 111. At step 730, the BNS 701 may provide the transaction details including the recipient information and the card details to transaction server 120. Based on the transaction details, at step 735, the transaction server 120 may in turn verify and provide the transaction details to the acquirer 125, the transaction processor 130, or the issuer 135. In some embodiments, at step 735, the transaction server 120 may assign a second PTID to assignee mobile device 108 and include the second PTID in the transaction details. Further, at step 735, the transaction server 120 may provide the transaction details including the PTID to the acquirer 125, the transaction processor 130, or the issuer 135. At step 740, the acquirer 125, the transaction processor 130, or the issuer 135 may provide a status notification indicating a success or failure of the financial transaction to the transaction server 120. At step 745, the transaction server 120 may in turn provide the status notification including transaction details and/or a transaction receipt to the BNS 701. The BNS 701 may then display a success or failure message to the assignee on the assignee mobile device 108 based on the status notification. The BNS 701 may also provide the transaction receipt in case of a successful NFC transaction that may be optionally viewed and/or stored in the assignee mobile device 108 by the assignee or automatically stored in one or more file formats. Further, in case of a failure of the NFC transaction, the BNS 701 may also provide reasons for the failure to the assignee via the user interface of the assignee mobile device 108. At step 750, the transaction server 120 may also provide the status notification to the BNS 260 in the user mobile device 105. The BNS 260 may in turn provide the status notification to the application 255. The application 255 may then display a success or failure message to the user on the user mobile device 105 based on the status notification. The application 255 may then display a success or failure message to the user based on the status notification. The application 255 may also provide the transaction receipt in case of a successful NFC transaction that may be optionally viewed and/or stored in the user mobile device 105 by the user or automatically stored in one or more file formats. Further, in case of a failure of the NFC transaction, application 255 may also provide reasons for the failure to the user via the user interface. In some embodiments, the steps 745 and 750 may be performed simultaneously.

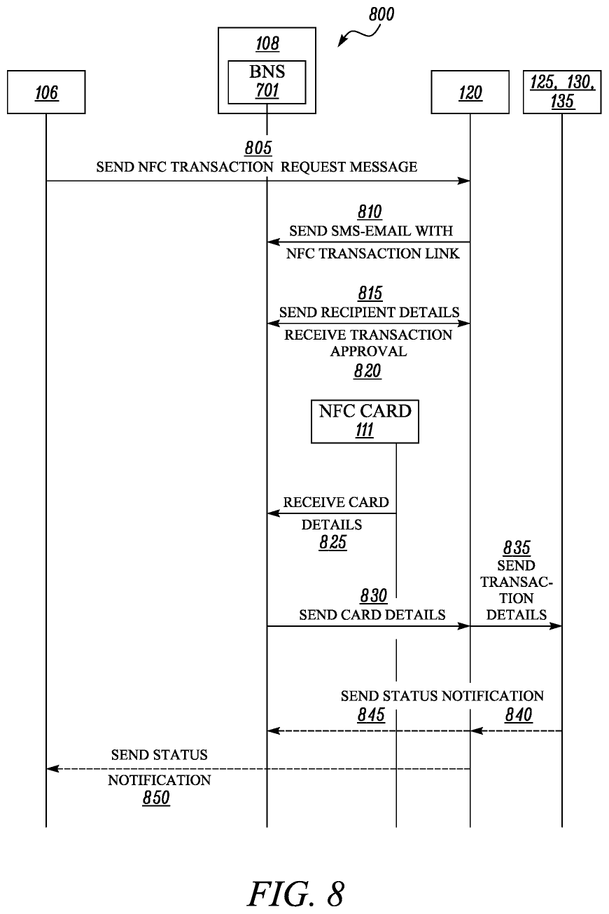

Referring to FIG. 8 an exemplary flow diagram of a method for managing an NFC transaction request sent by a user using the personal computer 106 of FIG. 1 to the assignee mobile device 108 of FIG. 1 is disclosed. At step 805, the user may initiate a financial transaction on a financial website requesting an assignee to initiate the NFC transaction on behalf of the user using the personal computer 106 of the user. Further, at step 805, the user may optionally choose an NFC checkout method or the NFC transaction option to complete the financial transaction in the financial website. The user may also provide assignee details such as, but not limited to, a phone number or a device ID associated with the assignee mobile device 108 or an email associated with the assignee. In some embodiments, the assignee details may also be prestored in the personal computer 106 of the user and may automatically be provided in the financial website. In addition, at step 805, the financial website may in turn provide an NFC transaction request together with the assignee details to the transaction server 120 in response the financial transaction initiated by the user. In some embodiments, at step 805, the financial website may also provide a recipient information to the transaction server 120 along with the NFC transaction request. In some embodiments, at step 810, the transaction server 120 may assign a first proxy terminal ID (PTID) to the personal computer 106. Further, at step 810, based on the assignee details, the transaction server 120 may provide the NFC transaction request including an NFC transaction link via an SMS, email, and/or a push notification to the assignee mobile device 108 in order to initiate the NFC transaction. At step 815, in response to the assignee clicking on or selecting the NFC transaction link, a BNS 701 provided in the assignee mobile device 108 may in turn provide the recipient information to the transaction server 120. At step 820, the transaction server 120 may verify the recipient based on the recipient information and provide a transaction approval to the BNS 701 in the assignee mobile device 108. Based on the transaction approval, at step 825, the BNS 701 may prompt the assignee via visual and/or auditory means to bring the NFC card 111 of the assignee in predefined proximity to the assignee mobile device 108. In some embodiments, step 815 and step 820 may be optional and/or omitted and step 825 may be performed without the transaction approval. The visual prompt may be in the form of a pop-up presented on the user interface of the assignee mobile device 108. At step 825, the BNS 701 may also receive the card details from the assignee's NFC card 111. At step 830, the BNS 701 may provide the transaction details including the recipient information and the card details to transaction server 120. Based on the transaction details, at step 835, the transaction server 120 may in turn verify and provide the transaction details to the acquirer 125, the transaction processor 130, or the issuer 135. In some embodiments, at step 835, the transaction server 120 may assign a second PTID to the assignee mobile device 108 and include the second PTID in the transaction details. Further, at step 835, the transaction server 120 may provide the transaction details including the second PTID to the acquirer 125, the transaction processor 130, or the issuer 135. At step 840, the acquirer 125, the transaction processor 130, or the issuer 135 may provide a status notification indicating a success or failure of the financial transaction to the transaction server 120. At step 845, the transaction server 120 may in turn provide the status notification including transaction details and/or a transaction receipt to the BNS 701. The BNS 701 may then display a success or failure message to the assignee on the assignee mobile device 108 based on the status notification. The BNS 701 may also provide the transaction receipt in case of a successful NFC transaction that may be optionally viewed and/or stored in the assignee mobile device 108 by the assignee or automatically stored in one or more file formats. Further, in case of a failure of the NFC transaction, the BNS 701 may also provide reasons for the failure to the assignee via the user interface of the assignee mobile device 108. At step 850, the transaction server 120 may also provide the status notification including transaction details and/or a transaction receipt to the financial website that may in turn display a success or failure message to the user on the personal computer 106 based on the status notification. In some embodiments, the steps 845 and 850 may be performed simultaneously.

Accordingly, the methods disclosed in the present disclosure enable the user to tap a physical NFC card, such as the NFC card 110 or use a virtual NFC card (not shown) using the user mobile device 105 rather than tapping the user's card at a merchant's POS device or terminal. Further, the methods disclosed in the present disclosure also help in avoiding an inconvenience and/or a risk associated with physical entry method of sensitive card details (SCD) and/or the storage of the SCD. In particular, the methods disclosed in the present disclosure help avoid the need for the user to input the SCD and/or personal information related to the user on merchant transaction systems. In addition, the methods disclosed in the present disclosure are implemented such that the BNS 260 in the user mobile device 105 and the transaction server 120 adhere to and are in compliance with stringent guidelines included in PCI Contactless Payments on COTS (CPoC) Standard. Conventionally, the PCI CPoC solutions enable contactless financial transactions on the merchant's consumer device, such as a smartphone, a tablet, or a POS terminal, using an embedded NFC interface. However, the methods disclosed in the present disclosure directly enable the user mobile device 105, rather than the merchant consumer device, to accept the contactless financial transactions or the NFC transaction while being compliant with the guidelines included in the PCI CPoC standard. Accordingly, the applications, including the merchant applications, in the user mobile device 105 may no longer have to certify respective offerings in order to be compliant with PCI-DSS stipulations since the BNS 260 manages the NFC transaction for the applications and the BNS 260 is a certified service that is compliant with the PCI CPoC standard. Furthermore, the methods disclosed in the present disclosure also enables the user to make the financial transaction on a device different from the user mobile device 105, such as the personal computer 106 and then initiate the NFC transaction using the user mobile device 105. In addition, by applying the methods disclosed in the present disclosure the user can enable other assignees to initiate the NFC card transactions on behalf of the user. Moreover, by applying the methods disclosed in the present disclosure any application in the user mobile device 105 can communicate with the BNS 260 using the local messaging object, such as “Android Intent” and leverage the NFC transaction facilitated by the BNS 260.

In the preceding specification, the present disclosure and its advantages have been described with reference to specific embodiments. However, it will be apparent to a person of ordinary skill in the art that various modifications and changes can be made, without departing from the scope of the present disclosure, as set forth in the claims below. Accordingly, the specification and figures are to be regarded as illustrative examples of the present disclosure, rather than in restrictive sense. All such possible modifications are intended to be included within the scope of present disclosure.

1. A Near-Field Communication (NFC)-enabled electronic device, comprising:
an NFC transceiver configured to facilitate an NFC-enabled interaction between the NFC-enabled electronic device and an NFC-enabled card;
a storage unit comprising a background NFC service (BNS) and one or more applications; and
a processor configured to execute one or more predefined computer instructions, wherein the storage unit further comprises computer program code configured to, with a processor cause the NFC-enabled electronic device to:
run the BNS at a platform-level as a background process in the NFC-enabled electronic device parallel to the one or more applications;
facilitate inter-communication between the one or more applications and the BNS via one or more service calls, wherein the one or more applications provides the NFC transaction request to the BNS via the one or more service calls; and
wherein the BNS further comprises computer program code configured to, with the processor, cause the NFC-enabled electronic device to:
retrieve recipient information from the NFC transaction request;
retrieve information indicative of one or more card details associated with the NFC-enabled card; and
provide the recipient information and the one or more card details from the NFC-enabled electronic device to a transaction server; and
provide a transaction status notification received from at least one of the transaction server, a transaction processor, an acquirer bank, or an issuer bank for display to a user, via a user interface, wherein the transaction status notification indicates a success or a failure of the NFC transaction.

2. The NFC-enabled electronic device of claim 1, wherein the storage unit and the computer program code are further configured to, with the processor, cause the NFC-enabled electronic device to: provide the NFC transaction request to the BNS in response to a selection of an NFC transaction option in the one or more applications.

3. The NFC-enabled electronic device of claim 1, wherein the BNS is part of an operating system of the NFC-enabled electronic device, without a user interface.

4. (canceled)

5. The NFC-enabled electronic device of claim 1, wherein the BNS further comprises computer program code configured to, with the processor, cause the NFC-enabled electronic device to prompt a user to use the NFC-enabled card in conjunction with the NFC-enabled electronic device on a user interface of the one or more applications or the NFC-enabled electronic device.

6. The NFC-enabled electronic device of claim 1, wherein the BNS further comprises computer program code configured to, with the processor, cause the NFC-enabled electronic device to retrieve the information indicative of the one or more card details and a security cryptogram associated with the NFC-enabled card on bringing the NFC-enabled card proximate to the NFC-enabled electronic device.

7. The NFC-enabled electronic device of claim 1, wherein the one or more service calls include local notifications, local asynchronous messaging objects, remote procedure calls (RPCs), operating system calls, integration capable libraries, calls made using software development kits (SDKs), remote push notifications, and scheduled local notifications.

8. A transaction server to monitor and attest an NFC transaction, comprising:
a processor configured to execute one or more predefined computer instructions to perform one or more functions, the one or more functions comprising:
receiving recipient information from one or more applications running on an NFC-enabled electronic device of a user via a background NFC service (BNS) provided in the NFC-enabled electronic device and a network, wherein the BNS runs as a background process parallel to the one or more applications and retrieves the recipient information from the one or more applications;
validating the recipient information;
assigning a proxy terminal identification (PTID) to the NFC-enabled electronic device;
receiving information indicative of one or more card details and a security cryptogram associated with an NFC-enabled card of the user via the BNS and the network, wherein the information indicative of the card details and the security cryptogram associated with the NFC-enabled card is retrieved by the BNS; and
providing the recipient information retrieved from each application of the one or more applications, the PTID, the information indicative of the one or more card details, and the security cryptogram to at least one of a transaction processor, an acquirer bank, or an issuer bank via the network.

9. The transaction server of claim 8, comprising:
receiving a transaction status notification from the at least one of the transaction processor, the acquirer bank, or the issuer bank, wherein the transaction status notification indicates a success or a failure of the NFC transaction; and
providing the transaction status notification to the NFC-enabled electronic device.

10. The transaction server of claim 8, wherein the transaction server assigns the PTID to a plurality of NFC-enabled electronic devices respectively that are similar to the NFC-enabled electronic device such that the PTID is distinct for the NFC-enabled electronic device and for each NFC-enabled electronic device of the plurality of NFC-enabled electronic devices, the PTID enabling the NFC-enabled electronic device and the plurality of NFC-enabled electronic devices to operate as proxy point-of-sale (POS) devices.

11. The transaction server of claim 8, wherein the BNS retrieves the information indicative of the one or more card details and the security cryptogram associated with the NFC-enabled card on bringing the NFC-enabled card proximate to the NFC-enabled electronic device to facilitate a “Card Present” (CP) transaction corresponding to the NFC transaction.

12. A system, comprising:
a Near-Field Communication (NFC)-enabled electronic device of a user, wherein the NFC-enabled electronic device comprises:
a background NFC service (BNS) that is configured to run on the NFC-enabled electronic device at a platform-level as a background process to facilitate an NFC transaction;
one or more applications running parallel to the BNS and configured to provide an NFC transaction request to the BNS via one or more service calls, wherein the BNS retrieves a recipient information from the NFC transaction request;
an NFC-enabled card of the user, wherein the BNS retrieves information indicative of one or more card details associated with the NFC-enabled card; and
a transaction server in communication with the NFC-enabled electronic device via a network, wherein:
the BNS provides the recipient information and the information indicative of the one or more card details from the NFC-enabled electronic device to the transaction server, and
the transaction server provides the recipient information and the information indicative of the one or more card details received to at least one of a transaction processor, an acquirer bank, or an issuer bank based on the recipient information and the information indicative of the one or more card details received.

13. The system of claim 12, wherein the transaction server validates the recipient information received and the BNS retrieves the information indicative of the one or more card details based on the validation of the recipient information by the transaction server, the BNS transmits a request to the transaction server for the validation, the transaction server then providing a validation status to the NFC-enabled electronic device in response to the request, the BNS receives the validation status from the transaction server, and the BNS retrieves and securely provides the information indicative of the one or more card details from the NFC-enabled electronic device to the transaction server based on the validation status.

14. The system of claim 12, comprising:
a second electronic device of the user enabling the user to provide the NFC transaction request to the user's NFC-enabled electronic device via the transaction server;
a third electronic device of a beneficiary enabling the beneficiary to provide the NFC transaction request to the user's NFC-enabled electronic device via the transaction server; and
a fourth NFC-enabled electronic device of an assignee initiating the NFC transaction on behalf of the user, wherein the user's NFC-enabled electronic device is enabling the user to provide the NFC transaction request to the assignee's fourth NFC-enabled electronic device via the transaction server, the fourth NFC-enabled electronic device including the BNS in order to initiate the NFC transaction.

15. The system of claim 14, wherein the transaction server provides the NFC transaction request received from:
the user's second electronic device to the user's NFC-enabled electronic device or the assignee's fourth NFC-enabled electronic device,
the beneficiary's third electronic device to the user's NFC-enabled electronic device, or
the user's NFC-enabled electronic device to the assignee's fourth NFC-enabled electronic device, via one or more alerts, the one or more alerts including a short-message-service (SMS), email, a pop-up notification, and a push notification, and the BNS retrieves the recipient information from the one or more alerts.

16. The system of claim 12, wherein the transaction server receives a transaction status notification and provides the transaction status notification, indicating a success or a failure of the NFC transaction, from at least one of the transaction processor, the acquirer bank, or the issuer bank to the NFC-enabled electronic device, the BNS providing the transaction status notification to the one or more applications.

17. The system of claim 12, wherein the transaction server is configured to:
assign a Proxy Terminal ID (PTID) to the NFC-enabled electronic device in order to enable the NFC-enabled electronic device to operate as a proxy point-of-sale (POS) device; and
provide the PTID in combination with the recipient information to at least one of a transaction processor, an acquirer bank, or an issuer bank, the BNS being configured to retrieve the recipient information from the NFC transaction request from each application of the one or more applications and provide the recipient information from each application to the transaction server.

18. The system of claim 12, wherein the BNS is configured to generate or retrieve a security cryptogram via the NFC-enabled card and provide the security cryptogram to the transaction server, and the transaction server is configured to provide the security cryptogram to at least one of the transaction processor, the acquirer bank, or the issuer bank in order to validate a “Card Present” (CP) transaction corresponding to the NFC transaction based on the recipient information and the information indicative of the one or more card details.

19. A method for facilitating a Near-Field Communication (NFC) transaction by a transaction server, the method comprising:
receiving recipient information from one or more applications running on an NFC-enabled electronic device of a user via a background NFC service (BNS) provided in the NFC-enabled electronic device and a network, wherein the BNS runs as a background process parallel to the one or more applications and retrieves the recipient information from the one or more applications;
assigning a proxy terminal identification (PTID) to the NFC-enabled electronic device;
receiving information indicative of one or more card details and a security cryptogram associated with an NFC-enabled card of the user via the BNS and the network, wherein the BNS retrieves the information indicative of the card details and the security cryptogram from the NFC-enabled card; and
providing the recipient information retrieved from each application of the one or more applications, the PTID, the information indicative of the one or more card details, and the security cryptogram to at least one of a transaction processor, an acquirer bank, or an issuer bank via the network.

20. The method of claim 19, wherein the receiving of the recipient information comprises:
validating the recipient information by the transaction server, wherein the recipient information includes recipient identification, recipient account details, and amount to be paid;
providing, by the transaction server, a validation status to the NFC-enabled electronic device; and
receiving the information indicative of the one or more card details and the security cryptogram based on the validation status, wherein the information indicative of the one or more card details includes a name of the user, credit card number, card verification value (CVV), and card expiry date.

21. The method of claim 19, comprising:
providing, by the transaction server, the NFC transaction request received from a second electronic device of the user to the user's NFC-enabled electronic device;
providing, by the transaction server, the NFC transaction request received from a third electronic device of a beneficiary to the user's NFC-enabled electronic device via the transaction server,
providing, by the transaction server, the NFC transaction request received from the user's NFC-enabled electronic device to a fourth NFC-enabled electronic device of an assignee to initiate the NFC transaction on behalf of the user, or
providing, by the transaction server, the NFC transaction request received from user's second electronic device to the assignee's fourth NFC-enabled electronic device to initiate the NFC transaction on behalf of the user.

22. The method of claim 21, wherein the providing of the NFC transaction request by the transaction server is via one or more alerts, the one or more alerts including a short-message-service (SMS), email, a pop-up notification, and a push notification.
